(19) United States
(12) Patent Application Publication
(10) Pub. No.: US 2026/0107186 A1
(43) Pub. Date: Apr. 16, 2026

(54) GENERATIVE MODELS FOR CSI ESTIMATION, COMPRESSION AND RS OVERHEAD REDUCTION

(71) Applicant: INTERDIGITAL PATENT HOLDINGS, INC., Wilmington, DE (US)

(72) Inventors: Akshay MALHOTRA, San Jose, CA (US); Yugeswar Deenoo NARAYANAN THANGARAJ, Chalfont, PA (US); Mohamed Salah IBRAHIM, Chesterbrook, PA (US); Arman SHOJAEIFARD, London (GB); Moon IL LEE, Melville, NY (US); Shahab HAMIDI-RAD, Sunnyvale, CA (US); Mihaela BELURI, Jericho, NY (US)

(73) Assignee: INTERDIGITAL PATENT HOLDINGS, INC., Wilmington, DE (US)

(21) Appl. No.: 19/116,211

(22) PCT Filed: Sep. 28, 2023
(86) PCT No.: PCT/US2023/034020

§ 371 Date: Mar. 27, 2025

Related U.S. Application Data
(60) Provisional application No. 63/410,954, filed on Sep. 28, 2022.

(51) Int. Cl. H04W 28/06; H04W 24/10

(52) U.S. Cl. CPC H04W 28/06; H04W 24/10

(57) ABSTRACT

Disclosed herein are one or more systems, methods, and/or devices for the estimation of the channel state information (CSI) using generative models. In some cases, there may also be simultaneously estimating a compressed representation of the CSI. In some cases, approaches and techniques may reduce the required reference symbols (RS) for the channel estimation process.

### CROSS-REFERENCE TO RELATED APPLICATIONS

This application claims the benefit of U.S. Provisional Application No. 63/410,954, filed Sep. 28, 2022 the contents of which are incorporated herein by reference.

### BACKGROUND

In the field of wireless communications, there is a need to improve the efficiency of transmission. For example, when sending feedback, it may be beneficial to find a way in which to reduce the size of this transmission.

### SUMMARY

Disclosed herein are one or more systems, methods, and/or devices for the estimation of the channel state information (CSI) using generative models. In some cases, there may also be simultaneously estimating a compressed representation of the CSI. In some cases, approaches and techniques may reduce the required reference symbols (RS) for the channel estimation process.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a data exchange between a WTRU and a base station;

FIG. 3 illustrates an example of CSI measurement setting(s);

FIG. 4 illustrates an example of codebook-based precoding with feedback information;

FIG. 5 illustrates an example of auto-encoder training for channel matrix compression;

FIG. 6 illustrates an example of utilizing decoder/generative model for MIMO channel estimation;

FIG. 7 illustrates an example of the generation and transmission of compressed CSI;

FIG. 8 illustrates an example of using a holdout-set for RS selection;

FIG. 9 illustrates an example process of transmitting a latent vector; and

FIG. 10 illustrates an example process of transmitting an optimized subset of RS.

### DETAILED DESCRIPTION

Table 1 comprises a non-exhaustive list of acronyms that be used herein.

TABLE 1

| | |
|---|---|
| Δf | Sub-carrier spacing |
| base | NR NodeB |
| station | |
| ACK | Acknowledgement |
| AI | Artificial Intelligence |
| AI/ML | Artificial Intelligence/Machine Learning |
| BLER | Block Error Rate |
| BWP | Bandwidth Part |
| CAP | Channel Access Priority |
| CAPC | Channel access priority class |
| CCA | Clear Channel Assessment |
| CCE | Control Channel Element |
| CE | Control Element |
| CG | Configured grant or cell group |
| CNN | Convolutional Neural Network |
| CP | Cyclic Prefix |
| CP-OFDM | Conventional OFDM (relying on cyclic prefix) |
| CQI | Channel Quality Indicator |
| CRC | Cyclic Redundancy Check |
| CSI | Channel State Information |
| CW | Contention Window |
| CWS | Contention Window Size |
| CO | Channel Occupancy |
| CU | Central Unit |
| D2D | Device to Device transmissions (e.g., LTE Sidelink) |
| DAI | Downlink Assignment Index |
| DCI | Downlink Control Information |
| DFI | Downlink feedback information |
| DG | Dynamic grant |
| DL | Downlink |
| DM-RS | Demodulation Reference Signal |
| DNN | Deep Neural Network |
| DRB | Data Radio Bearer |
| DU | Distributed Unit |
| EN-DC | E-UTRA - NR Dual Connectivity |
| EPC | Evolved Packet Core |
| FDD | Frequency Division Duplexing |
| FDM | Frequency Division Multiplexing |
| eLAA | enhanced Licensed Assisted Access |
| FeLAA | Further enhanced Licensed Assisted Access |
| HARQ | Hybrid Automatic Repeat Request |
| LAA | License Assisted Access |
| LBT | Listen-Before-Talk |
| LTE | Long Term Evolution e.g., from 3GPP LTE R8 and up |
| NACK | Negative ACK |
| MCS | Modulation and Coding Scheme |
| MIMO | Multiple Input Multiple Output |
| ML | Machine Learning |
| MTC | Machine-Type Communications |
| MR-DC | Multi-RAT Dual Connectivity |
| NN | Neural Network |
| NR | New Radio |
| OFDM | Orthogonal Frequency-Division Multiplexing |
| OOB | Out-Of-Band (emissions) |
| Pcmax | Total available WTRU power in a given transmission interval |
| Pcell | Primary cell of Master Cell Group |
| PScell | Primary cell of a Secondary cell group |
| PCG | Primary Cell Group |
| PDU | Protocol Data Unit |
| PER | Packet Error Rate |
| PHY | Physical Layer |
| PRB | Physical Resource Block |
| PID | Process ID |
| PO | Paging Occasion |
| PRACH | Physical Random Access Channel |
| PSS | Primary Synchronization Signal |
| RA | Random Access (or procedure) |
| RACH | Random Access Channel |
| RAR | Random Access Response |
| RCU | Radio access network Central Unit |
| RF | Radio Front end |
| RLF | Radio Link Failure |
| RLM | Radio Link Monitoring |
| RNN | Recurrent Neural Network |
| RNTI | Radio Network Identifier |
| RO | RACH occasion |
| RRC | Radio Resource Control |
| RRM | Radio Resource Management |
| RS | Reference Signal |
| RSRP | Reference Signal Received Power |
| RSSI | Received Signal Strength Indicator |
| RTT | Round-Trip Time |
| SDU | Service Data Unit |
| SRS | Sounding Reference Signal |
| SS | Synchronization Signal |
| SSS | Secondary Synchronization Signal |
| SWG | Switching Gap (in a self-contained subframe) |
| SPS | Semi-persistent scheduling |
| SUL | Supplemental Uplink |
| TB | Transport Block |
| TBS | Transport Block Size |
| TDD | Time-Division Duplexing |
| TDM | Time-Division Multiplexing |
| TI | Time Interval (in integer multiple of one or more symbols) |
| TTI | Transmission Time Interval (in integer multiple of one or more symbols) |
| TRP | Transmission/Reception Point |
| TRPG | Transmission/Reception Point Group |
| TRx | Transceiver |
| TSC | Time-sensitive communications |
| TSN | Time-sensitive networking |
| UL | Uplink |
| UNN | Untrained Neural Network |
| URLLC | Ultra-Reliable and Low Latency Communications |
| WBWP | Wide Bandwidth Part |
| WLAN | Wireless Local Area Networks and related technologies (IEEE 802.xx domain) |

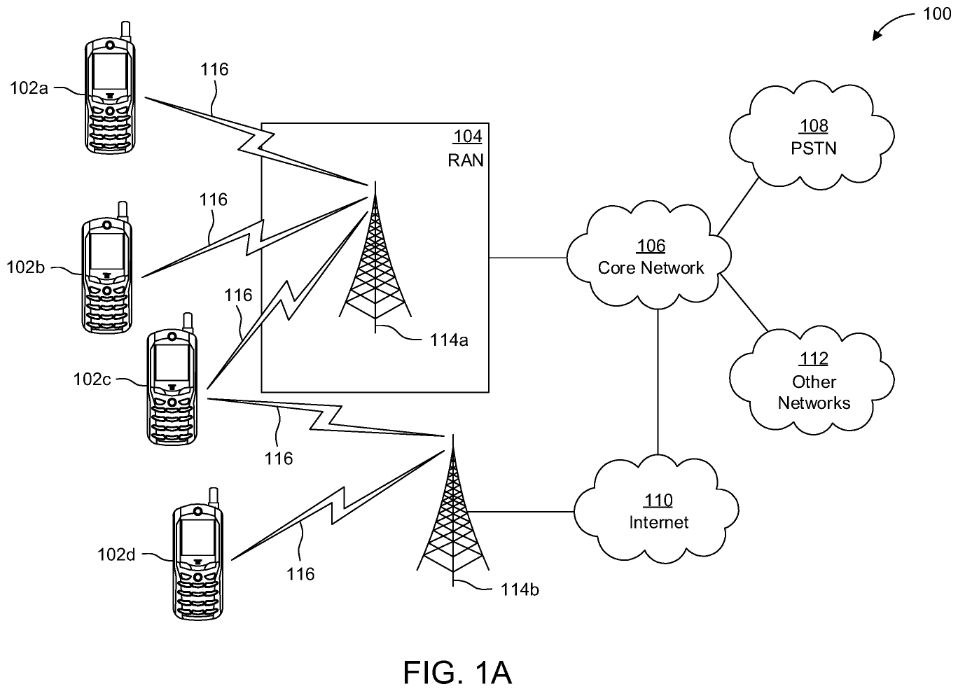

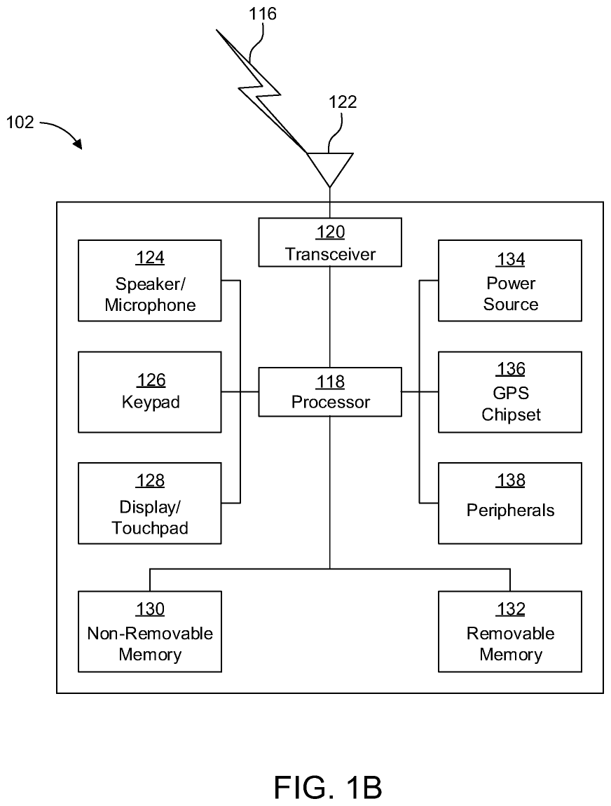

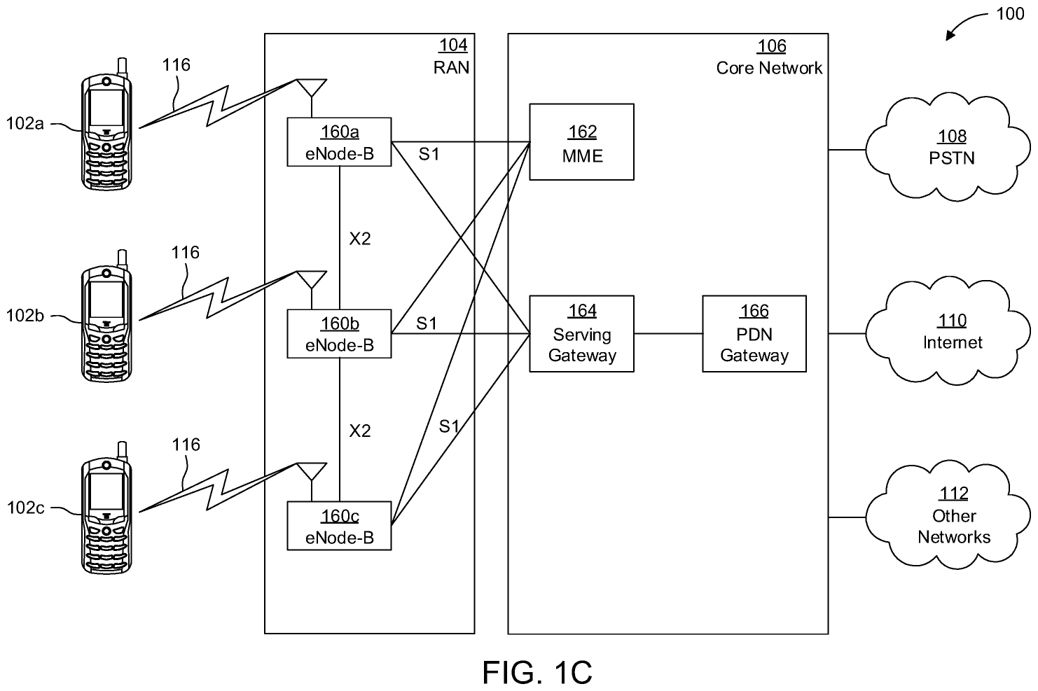

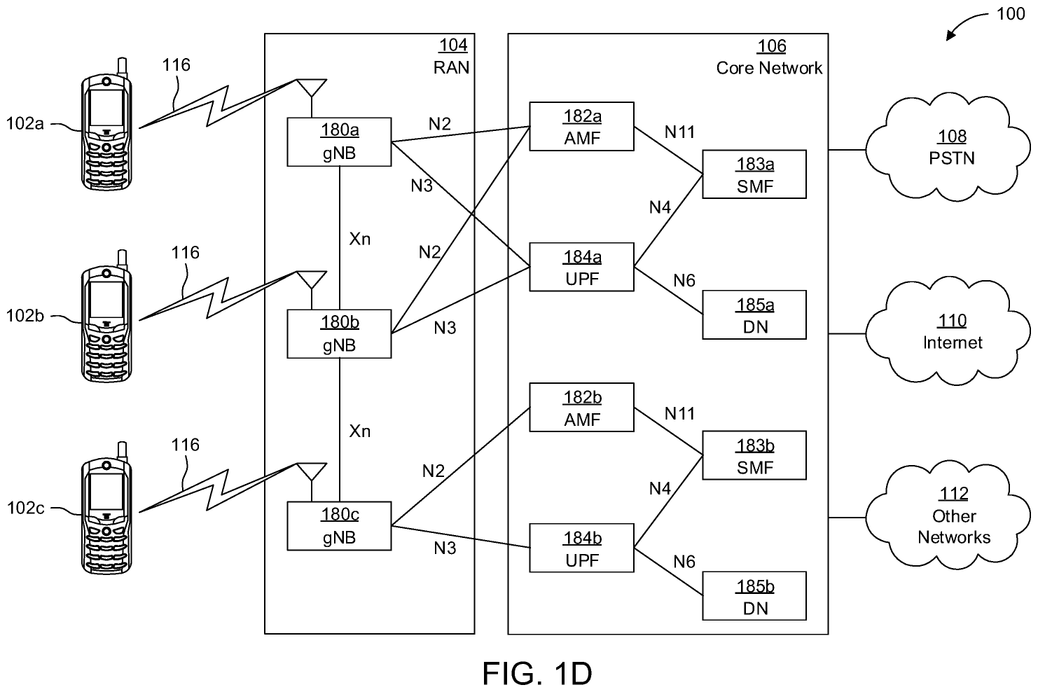

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), and the like. While the base stations 114a, 114b are each depicted as a single element, it will be appreciated that the base stations 114a, 114b may include any number of interconnected base stations and/or network elements. A TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), but still consistent with this invention. Hereafter, Multi-TRP may be interchangeably used with one or more of MTRP, M-TRP, and multiple TRPs, but still consistent with this disclosure.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and Qos, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may incorporate Artificial Intelligence (AI) and/or Machine Learning (ML) into a respective operation. Artificial intelligence may be broadly defined as the behavior exhibited by machines, where the behavior may mimic cognitive functions to sense, reason, adapt, and/or act. For example, a wireless system may utilize AI to reduce the overhead of transmissions (e.g., an AI/ML model may be used to generate a value using one or more inputs, where the transmission may be reduced by only needing to send the one or more inputs, and the model can be used at the receiver (e.g., already known or indicated in some way) to generate the value such that the sender will have effectively shared this value with the receiver, even though the value itself was not transmitted).

Machine learning refers to the type of algorithms that solve a problem based on learning through experience (‘data’), without explicitly, or minimally, being programmed (‘configuring a set of rules’). Machine learning may be considered to be a subset of AI. Different machine learning paradigms may be envisioned based on the nature of data or feedback available to the learning algorithm. For example, a supervised learning approach may involve learning a function that maps input to an output based on a labeled training example, wherein each training example may be a pair consisting of input and the corresponding output. For example, an unsupervised learning approach may involve detecting patterns in the data with no pre-existing labels. For example, a reinforcement learning approach may involve performing a sequence of actions in an environment to maximize the cumulative reward. In some cases, it is possible to apply machine learning algorithms using a combination or interpolation of the above-mentioned approaches. For example, a semi-supervised learning approach may use a combination of a small amount of labeled data with a large amount of unlabeled data during training. In this regard semi-supervised learning falls between unsupervised learning (with no labeled training data) and supervised learning (with only labeled training data).

Deep learning refers to a class of machine learning algorithms that employ artificial neural networks (e.g., specifically deep neural networks, DNNs) which may be loosely inspired from biological systems. Deep Neural Networks (DNNs) are a special class of machine learning models inspired by the human brain wherein the input is linearly transformed and pass-through non-linear activation function multiple times. DNNs typically comprise of multiple layers where each layer consists of linear transformation and a given non-linear activation functions. The DNNs may be trained using the training data via back-propagation algorithm. Recently, DNNs have shown state-of-the-art performance in a variety of domains, such as speech, vision, natural language, and the like, and for various machine learning settings supervised, un-supervised, and semi-supervised. The term AI/ML based methods/processing may refer to a realization of behaviors and/or conformance to requirements by learning based on data, without explicit configuration of a sequence of steps of actions, and/or with a combination of configured sequences or steps of actions in addition to a learned sequence of steps or actions. Such methods may enable learning complex behaviors that might be difficult to specify and/or implement when using legacy methods.

Artificial Intelligence (AI), including Machine Learning (ML), may be applied to wireless transmitters and/or to wireless receivers. AI/ML may be used to improve one or more specific aspect(s), function(s) or protocol(s) operation of a wireless node, such as either as a local optimization within a node and/or as part of a function, or procedure over the air interface (AI-AI).

In some cases, AI/ML based methods may be used for high-resolution CSI feedback and better performance at reduced CSI-RS overhead. An autoencoder may be one of the AI/ML model architectures for CSI compression. Autoencoder architecture comprises of two parts: an encoder AI model (e.g., at the WTRU) and a decoder AI model (e.g., at the base station), both of which may be jointly trained/designed. The Encoder/Decoder may have multiple layers. In the encoder, the output of each layer is smaller than its input (e.g., vice versa for decoder). In some instances, a larger number of layers may result in a higher model complexity, which may result in higher storage requirement, which may result in higher training complexity, which may result in better performance/better compression ratio.

Channel State Information (CSI) may include at least one of the following: channel quality index (CQI), rank indicator (RI), precoding matrix index (PMI), an L1 channel measurement (e.g., RSRP such as L1-RSRP, or SINR), CSI-RS resource indicator (CRI), SS/PBCH block resource indicator (SSBRI), layer indicator (LI) and/or any other measurement quantity measured by the WTRU from the configured reference signals (e.g., CSI-RS or SS/PBCH block or any other reference signal).

A WTRU may be configured to report the CSI through the uplink control channel on PUCCH, or per the base stations' request on an UL PUSCH grant. Depending on the configuration, CSI-RS may cover the full bandwidth of a BandWidth Part (BWP) or just a fraction of it. Within the CSI-RS bandwidth, CSI-RS may be configured in each PRB or every other PRB. In the time domain, CSI-RS resources may be configured as periodic, semi-persistent, or aperiodic. Semi-persistent CSI-RS is similar to periodic CSI-RS, except that the resource may be (de)-activated by MAC CEs; and the WTRU may report related measurements only when the resource is activated. For Aperiodic CSI-RS, the WTRU may be triggered to report measured CSI-RS on PUSCH by request in a DCI. Periodic reports are carried over the PUCCH, while semi-persistent reports may be carried either on PUCCH or PUSCH. The reported CSI may be used by the scheduler when allocating optimal resource blocks possibly based on channel's time-frequency selectivity, determining precoding matrices, beams, transmission mode, and/or selecting suitable MCSs. The reliability, accuracy, and timeliness of WTRU CSI reports may be critical to meeting URLLC service requirements.

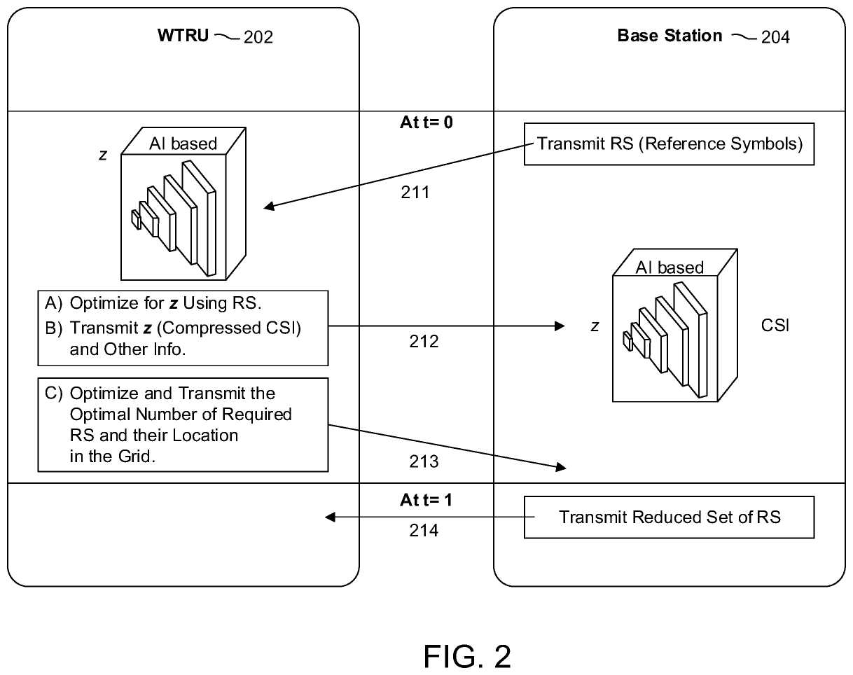

FIG. 2 illustrates an example of an AI/ML model enhanced exchange between a WTRU and a base station. As shown, there may be a WTRU 202 and a base station 204. At some initial time (e.g., t=0), the base station may send a set of reference signals at 211. The WTRU may measure/gather CSI for the reference signals. The WTRU 202 may have an AI based model with a latent vector (z) as its input, which when inputted into the AI based model generates the CSI (e.g., the same or as close to the originally measured CSI as possible). At (A) the WTRU may optimize for z using the reference signals. The WTRU at (B), the WTRU may transmit z (e.g., which may be considered to be the compressed CSI). At 212 the base station receives z and may use this to determine the CSI. In some instances, the WTRU may transmit additional information along with z. At (C) the WTRU may optimize the optimal number of required reference signals and their location in a grid. At 213, the WTRU may send this information to the base station. At some point after or during the initial exchange (e.g., on or after t=1), the base station my send a reduced set of reference signals at 214 (e.g., while sending z or when sending information about a reduced set, as further described herein).

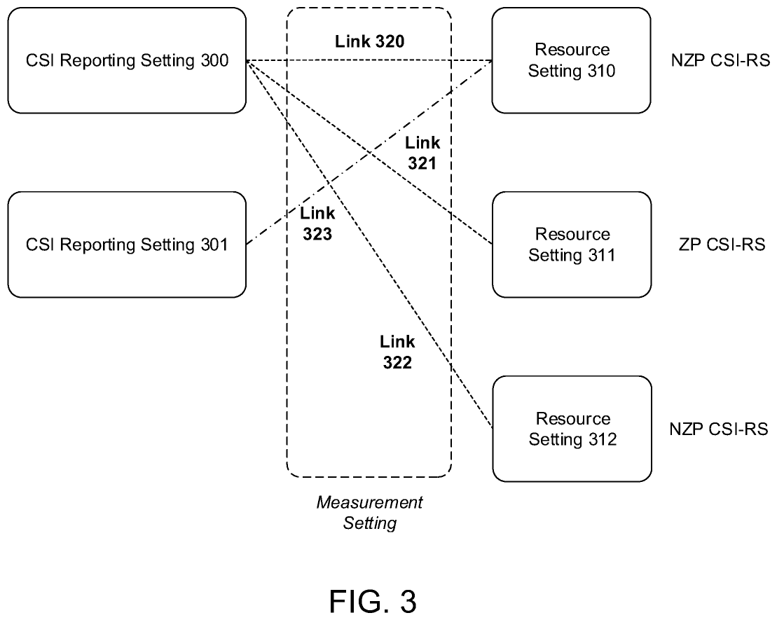

FIG. 3 illustrates an example of CSI measurement setting(s). A WTRU may be configured with a CSI measurement setting which may include one or more CSI reporting settings (e.g., 300 and 301), resource settings (e.g., 310, 311, 312), and/or a link between one or more CSI reporting settings and one or more resource settings (e.g., 320, 321, 322, 323). As shown in this example, there are a number of possible configurations for CSI reporting settings, resource settings, and links. For example, there may be resource settings for non-zero-power CSI reference signals (NZP CSI RS) and zero power CSI RS (ZP CSI RS).

In a CSI measurement setting, there may be a one or more configuration parameters provided.

For example, one configuration parameter may be N≥1 CSI reporting settings, M≥1 resource settings, and a CSI measurement setting that links the N CSI reporting settings with the M resource settings.

For example, one configuration parameter may be a CSI reporting setting that includes at least one of the following: Time-domain behavior; aperiodic or periodic/semi-persistent; Frequency-granularity, at least for PMI and CQI; CSI reporting type (e.g., PMI, CQI, RI, CRI, etc.); and/or, if a PMI is reported, PMI Type (Type I or II) and codebook configuration.

For example, one configuration parameter may be a resource setting that includes at least one of the following: Time-domain behavior; aperiodic or periodic/semi-persistent; RS type (e.g., for channel measurement or interference measurement); and/or, a S≥1 resource set(s), where each resource set may contain Ks resources.

For example, one configuration parameter may be a CSI measurement setting that includes at least one of the following: One CSI reporting setting; One resource setting; and/or, for CQI, a reference transmission scheme setting.

For example, one configuration parameter may be CSI reporting for a component carrier, at one or more of the following frequency granularities that may be supported: Wideband CSI; Partial band CSI; and/or, Sub band CSI.

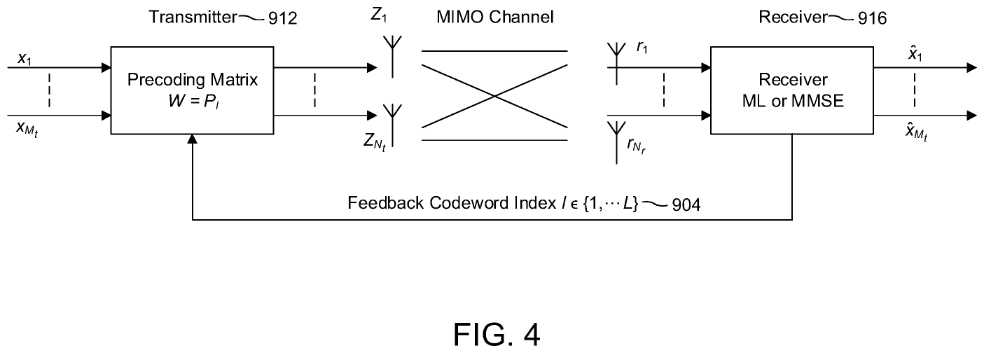

FIG. 4 illustrates an example of codebook-based precoding with feedback information. For a MIMO scenario, as shown, there is a transmitter 912 and receiver 916, each with a plurality of antennas, demonstrating the concept of codebook-based precoding with feedback information (e.g., the feedback shown at 904). The feedback information may include a precoding matrix index (PMI) which may be referred to as a codeword index in the codebook as shown in the figure.

As shown in the example of FIG. 4, a codebook may include a set of precoding vectors/matrices for each rank and the number of antenna ports, and each precoding vector/matrix has its own index so that the receiver 916 may inform preferred precoding vector/matrix index to the transmitter 912. The codebook-based precoding may have performance degradation due to its finite number of precoding vectors/matrices as compared with non-codebook-based precoding, however, a major advantage of codebook-based precoding may be lower control signaling/feedback overhead.

Table 2 shows an example of a codebook for 2Tx.

TABLE 2

| Codebook | Number of rank | |
|---|---|---|
| index | 1 | 2 |
| 0 | $\frac{1}{\sqrt{2}} [ \begin{matrix}1 \\ 1\end{matrix} ]$ | $\frac{1}{\sqrt{2}} [ \begin{matrix}1 & 0 \\ 0 & 1\end{matrix} ]$ |
| 1 | $\frac{1}{\sqrt{2}} [ \begin{matrix}1 \\ - 1\end{matrix} ]$ | $\frac{1}{2} [ \begin{matrix}1 & 1 \\ 1 & - 1\end{matrix} ]$ |
| 2 | $\frac{1}{\sqrt{2}} [ \begin{matrix}1 \\ j\end{matrix} ]$ | $\frac{1}{2} [ \begin{matrix}1 & 1 \\ j & - j\end{matrix} ]$ |
| 3 | $\frac{1}{\sqrt{2}} [ \begin{matrix}1 \\ - j\end{matrix} ]$ | — |

A CSI processing unit (CSIU) may be referred to as a minimum CSI processing unit and a WTRU may support one or more CSI processing units (e.g., N CSIUs). A WTRU with N CSIUs may estimate N CSI feedbacks calculation in parallel, wherein N may be a WTRU capability. If a WTRU is requested to estimate more than N CSI feedbacks at the same time, the WTRU may only perform high priority N CSI feedbacks and the rest may be not estimated.

The starts and ends of a CSIU may be determined based on the CSI report type (e.g., aperiodic, periodic, semi-persistent) as following: for aperiodic CSI report, a CSIU starts to be occupied from the first OFDM symbol after the PDCCH trigger until the last OFDM symbol of the PUSCH carrying the CSI report; and/or, for periodic and semi-persistent CSI report, a CSIU starts to be occupied from the first OFDM symbol of one or more associated measurement resources (not earlier than CSI reference resource) until the last OFDM symbol of the CSI report

The number of CSIUs occupied may be different based on the CSI measurement types (e.g., beam-based or non-beam based) as following: Non-beam related reports, where Ks CSIUs when Ks CSI-RS resources in the CSI-RS resource set for channel measurement; Beam-related reports (e.g., “cri-RSRP”, “ssb-Index-RSRP”, or “none”), where 1 CSIU irrespective of the number of CSI-RS resource in the CSI-RS resource set for channel measurement due to the CSI computation complexity is low, or “none” is used for P3 operation or aperiodic TRS transmission; For an aperiodic CSI reporting with a single CSI-RS resource, where 1 CSIU is occupied; and/or, for a CSI reporting Ks CSI-RS resources, where Ks CSIUs are occupied as the WTRU needs to perform CSI measurement for each CSI-RS resource.

When the number of unoccupied CSIUs (Nᵤ) is less than required CSIUs (Nᵣ) for CSI reporting, the following WTRU behavior may be used: the WTRU may drop Nᵣ−Nᵤ CSI reporting based on priorities in the case of UCI on PUSCH without data/HARQ; and/or, the WTRU may report dummy information in Nᵣ−Nᵤ CSI reporting based on priorities in other case to avoid rate-matching handling of PUSCH

Artificial Intelligence (AI), including Machine Learning (ML), may be applied to wireless transmitters and/or to wireless receivers. AI/ML may be used to improve one or more specific aspect(s), function(s) or protocol(s) operation of a wireless node e.g., either as a local optimization within a node and/or as part of a function, or procedure over the air interface (AI-AI).

In one or more embodiments, there may be a generative model derived from a autoencoder based framework for channel estimation, CSI compression, and/or RS overhead reduction. These techniques may address one or more of the following: Minimization of specification impact and have an approach that is WTRU vendor friendly (e.g., only decoder needs to be specified, encoder is not required); Allow for multiple functions to be done simultaneously (e.g., CSI compression, Channel estimation, Identification of optimal pilot density+pilot positions, etc.); and/or, improve accuracy of channel estimation and compression (e.g., adding supplemental prior information for improved reconstruction, and/or supplemental information may be added as a regularizer too, where regularizer refers to an additional component added to the loss function or the optimization problem. The regularizer may represent some prior information, a penalty or an additional constraint).

For generative model training, the overall framework may use a generative model, also referenced as a decoder model, that takes as input a latent vector, also referenced as compressed representation or Z herein, and generates an estimate of a channel matrix H2. The generative model may be trained either as an auto-encoder or using a generative adversarial network.

For the autoencoder styled training, the generative neural network model/decoder model may be trained in tandem with an encoder neural network model. During the training process, a channel matrix H from the training dataset is fed as input to the encoder model, φ₁(⋅) which produces a compressed representation Z=φ₁ (H), which in-turn serves as the input to the decoder model, φ₂(⋅). The output H2=φ₁(Z), of the decoder model is utilized for evaluating a loss and training both the encoder and decoder models.

An example of the training loss is the mean square error between the input channel matrix H and the decoder output H2, and may be expressed as:

$$Training loss = {min}_{{ϕ}_{1} , {ϕ}_{2}} {\vert \vert H - H 2 \vert \vert}_{p} ,$$

where, ∥⋅∥ₚ, refers to the p-norm operator.

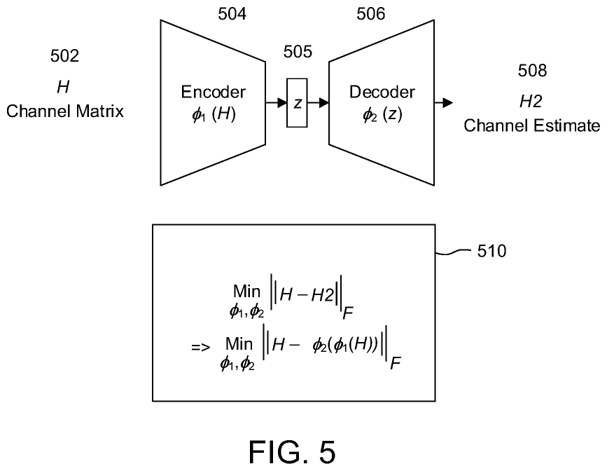

FIG. 5 illustrates an example of auto-encoder training for channel matrix compression. As shown, an encoder 504 may accept a channel matrix H 502 as input, which produces the latent vector (z) 505. The latent vector 505 may then be used as the input to the decoder model 506 to produce H2 channel estimate 508. In this example, the training loss may be minimized as shown at 510. Post training (not shown), the encoder model φ₁(⋅) may be discarded and only the decoder model φ₂(⋅) may be utilized for further processing. The same decoder model may be deployed at both the WTRU and the base station, and may be utilized for the dual purpose of channel estimation and channel compression. For reference, the equation shown in the figure at 510 is reproduced here:

$${min}_{{ϕ}_{1} , {ϕ}_{2}} {\vert \vert H - H 2 \vert \vert}_{F} \text{=>} {min}_{{ϕ}_{1} , {ϕ}_{2}} {\vert \vert H - {ϕ}_{2} ( {ϕ}_{1} ( H ) ) \vert \vert}_{F}$$

During inference or the operational stage, the WTRU receives the CSI-RS at pre-configured REs and utilizes some or all of them to optimize for the latent Z. As the latent is obtained.

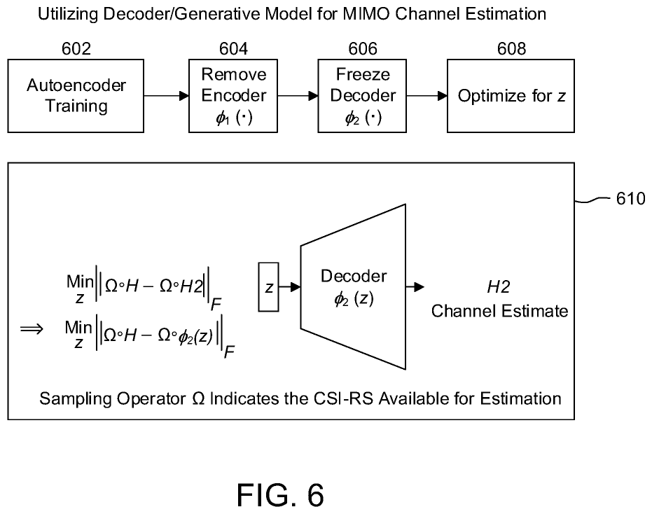

FIG. 6 illustrates an example of utilizing a decoder/generative model for MIMO channel estimation. As shown, the overall process may be represented by several stages/steps. Initially, at 602, there may be autoencoder training. At 604, the encoder may be removed. At 606, the decoder may be frozen, which refers to freezing the weights of the decoder network, so that the latent vector can be optimized, at 608. 610 shows training loss of the function for the latent vector, where the sampling operator Ω may indicate the CSI-RS available for estimation. For reference, the equation shown in the figure at 610 is reproduced here:

$${min}_{z} {\vert \vert Ω ∘ H - Ω ∘ H 2 \vert \vert}_{F} ⇒ {min}_{z} {\vert \vert Ω ∘ H - Ω ∘ {ϕ}_{2} ( z ) \vert \vert}_{F}$$

The generative model or decoder model φ₂(⋅) may also be learned as a generative adversarial network (GAN) or Variational Auto Encoder (VAE) to map the latent representation or compressed representation, Z, to the estimated channel matrix H2. As a GAN, the model is specifically learned in a generator-discriminator setting using an adversarial loss. In such a setting the generator model aims at producing channel matrices ‘similar’ to the ones available in a training dataset and the discriminator aims at distinguishing classifying if an input channel matrix is obtained from a training dataset or is generated using the generative model.

During the inference or the operational stage, the trained model may be utilized similarly to the generative model trained in the autoencoder setting. The WTRU receives the CSI-RS at pre-configured REs and utilizes some or all of them to optimize for the latent Z. As the latent is obtained.

For a generative model, trained as a GAN, the model may be trained to utilize some prior information or characteristics of the channel as an additional conditional input to the generator model. For example, if rank of the matrix is known ahead, the GAN may be conditioned to produce a channel matrix with a specified rank. Any other property or information of the channel matrix, that may have an impact on channel estimation, and is known ahead, may also be utilized for channel estimation.

In such a setting, the training procedure of the model has to be modified to include and ensure the conditional arguments are satisfied. The input to the generator may use two components, one similar to the latent representation Z and additionally, a second component indicating the prior knowledge which the model needs to be conditioned upon. During the training, the standard adversarial loss is supplemented with a secondary loss function to minimize the error between the prior known property or channel characteristic and a measure of the property or channel characteristic from the estimated channel generated channel H2. Detailed discussion around the potential impact of having conditionally generative models for channel estimation and CSI feedback is discussed further herein.

A WTRU may be configured to determine a channel estimate and report the CSI feedback comprising a latent/compressed/low-dimensional vector z compatible with a preconfigured decoder AI/ML model. The decoder model may be, for example, the decoder part of a trained autoencoder model or a separately trained GAN, as discussed herein. The signaled latent vector z may then be used at the base station to reconstruct the CSI (or a quantity thereof) using the decoder AI/ML model. The reconstructed CSI, H2, may have one or more representations.

For example, the reconstructed CSI may represent the full wideband CSI of dimension Nᵣ×Nₜ×N_{SB}, where Nᵣ, Nₜ, and N_{SB} denote the number of receive antenna ports, the number of transmit antenna ports and the number of configured subbands, respectively.

For example, the reconstructed CSI may represent the measured/estimated channel at some resource elements (e.g., the preconfigured CSI-RS locations), where the dimension of the reconstructed CSI is Nᵣ×Nₜ×Nᵣₑₛ, where Nᵣₑₛ may denote the number of configured reserved REs for CSI-RS reception or part thereof.

For example, the reconstructed CSI may represent the received signals or (part thereof) at the configured CSI-RS locations, where reconstructed CSI is of size N_{totalCSIRS}, the number of measurements at the configured CSI-RS locations.

In some cases, the WTRU may be configured to derive a latent vector z based on one or more decoder AI/ML model configurations. The WTRU may be configured to determine the latent vector z based on a specific preconfigured decoder AI/ML model mirrored at both communication nodes. The WTRU may use the configured decoder AI/ML model mapping function φ₂(⋅) to optimize the low-dimensional latent vector z. The latent vector may be further utilized for the dual purpose of channel estimation and CSI feedback. At the WTRU, the latent vector z may be used with the decoder model to estimate the channel matrix. Additionally, the latent vector z may be signaled to the base station and may be utilized to reconstruct the channel at the base station side.

In another option, the WTRU may be configured to select one from multiple preconfigured decoder models

$$( {ϕ}_{2}^{( 1 )} , … , {ϕ}_{2}^{( N )} ) ,$$

where the selected decoder may satisfy a certain preconfigured reconstruction error threshold ϵₑᵣᵣ (e.g., a preconfigured NMSE). For example, the WTRU may select the decoder that yields the closest reconstruction error to the preconfigured threshold ϵₑᵣᵣ. If configured to select one of multiple (N) decoder AI/ML models, the WTRU may indicate the selected model index together with the associated latent vector to the base station.

The quality of CSI reconstruction at the base station is dependent on how well-optimized the latent vector z is. One aspect that affects the quality of the optimized latent vector z is the selection of the loss function. The choice of the loss function may ensure a high-quality approach for the latent vector z, that may yield an acceptable CSI reconstruction at the base station. The WTRU may be configured to determine a latent vector z that is optimized to minimize a preconfigured loss function L. The WTRU may be configured with one of multiple loss functions to use to find the latent vector z. For example, the loss function may be the normalized mean squared error (NMSE) or the cosine similarity (CS) or it may be directly designed to maximize the system throughput. The loss function may be configured to have two loss components L1 and L2, such that L is a weighted combination of L1 and L2, such as L=L1+αL2, and α is the scaling/weighting factor.

The first loss component, L1, may represent the main function while the second loss component, L2, may represent a specific property of the channel. The first loss component, L1, may be one or more variations.

The first loss component, L1, may be the NMSE of the difference between H1 and the estimated channel at the decoder output H2:=φ₂(z), i.e.,

$$L 1 = {‖ H 1 - {ϕ}_{2} ( z ) ‖}_{F}^{2} ,$$

where H1 is the channel obtained using CSI-RS at the WTRU.

The first loss component, L1, may be the correlation between H1 and H2:=φ₂(z), i.e., L1=−Re(tr (H1*H2)), and the goal is to find z that maximizes the correlation.

The first loss component, L1, may be the throughput, i.e.,

$$L 1 = - {log}_{2} ( 1 + \frac{{‖ H 1 v ‖}^{2}}{{σ}^{2}} ) ,$$

where ν represents the principal eigenvector of the reconstructed channel φ₂(z).

The first loss component may be selected by the WTRU or it may be configured by the base station. For example, in case of eigenvector precoding, the base station may configure the WTRU with a first loss component that tends to optimize the latent vector z in a way that reconstructs the channel eigenvectors as opposed to the channel matrix. In such a case, the first loss component may be chosen as

$$L1 = {‖ {v}_{1} - f ( ϕ ( z ) ) ‖}_{F}^{2} ,$$

where ν₁ is the principal eigenvector of the estimated channel and f(⋅) returns the maximum eigenvector of the reconstructed channel.

Whereas the second loss component, L2, captures a specific property of the channel. An example of this property may be that the estimated channel may be ‘low rank’ or ‘sparse’. For example, the low rank constraint/regularizer may be enforced by using the second loss component, L2, as the Nuclear Norm. The low rank regularizer has several advantages; where it may provide robustness to noise and may effectively reduce the number of CSI-RS required to meet a specific reconstruction performance and may improve the channel estimation accuracy. On the other hand, the sparsity constraint may be enforced via using the second loss component, L2, as the l₁-Norm or using a group sparsity Norm as the l_{1,2}-Norm. The sparsity constraint may reduce the uplink overhead associated with the latent vector z. The property induced by the second loss component may be configured by the base station, or it may be selected by the WTRU from multiple preconfigured properties. For example, the WTRU may select the second loss component based on some channel characteristics or parameters, for example, delay spread or channel rank.

A WTRU may be configured with a weighting parameter α that weighs L2 w.r.t L1, where a may take several preconfigured values. The WTRU may determine the value of a using a brute-force approach and signal back the one that yields the minimum reconstruction error. In another option, the WTRU may select the value of a based on channel measurements. For example, if the channel is measured to be a low-rank, then the WTRU may select a high weight for the second loss components that enforces a low-rank property of the channel. If the channel is not low rank, then the WTRU may set a to be equal to zero to eliminate the impact of the second loss component.

The first loss component may be configured via RRC configuration while the second loss component and a set of preconfigured values of α may be configured semi-statically or dynamically (e.g., via MAC CE or L1 signaling).

In some case, CSI feedback may be optimized by using loss information and reporting latent information. A WTRU may be configured, indicated, or requested to transmit CSI feedback report, or quantity thereof, containing at least the latent vector z or a quantized/coded version thereof. The latent vector z may be referred to a CSI reporting quantity (e.g., AI/MLDecoderLatent). The maximum size of the latent vector z may be determined based on the capacity of the uplink feedback resource configured, or it may be configured by higher layer (e.g., RRC, MAC-CE). The WTRU may indicate the optimized latent vector z through uplink signaling to be used for channel reconstruction at the base station. The report may indicate the latent vector in one or more scenarios.

For example, in one scenario, if the WTRU is configured to select one of multiple preconfigured decoder AI/ML models, the WTRU may indicate the selected decoder model used to generate the latent vector z.

For example, in one scenario, if the WTRU is configured to select the second loss component L2 from multiple preconfigured loss functions, then the WTRU may report the index of the selected loss function L2. The different loss functions may have different tunable parameters. In that case, the WTRU may be configured to indicate one or more of the parameters associated with the selected loss function.

For example, in one scenario, if the WTRU is configured to indicate the weightage parameter, α, then the WTRU may indicate the selected value.

The signaling may be done explicitly through a modified UCI, using PUCCH and/or PUSCH, or implicitly using a specific PUCCH or RACH resource. In an option, the WTRU may be configured with UCI resources with various formats. The different formats have different number of bits resource blocks, etc, to indicate the reporting information associated with the latent vector. For example, the trigger format may indicate including the latent vector together with the selected AI/ML decoder model. In another option, a format may indicate including the latent vector with the second loss component information or part thereof.

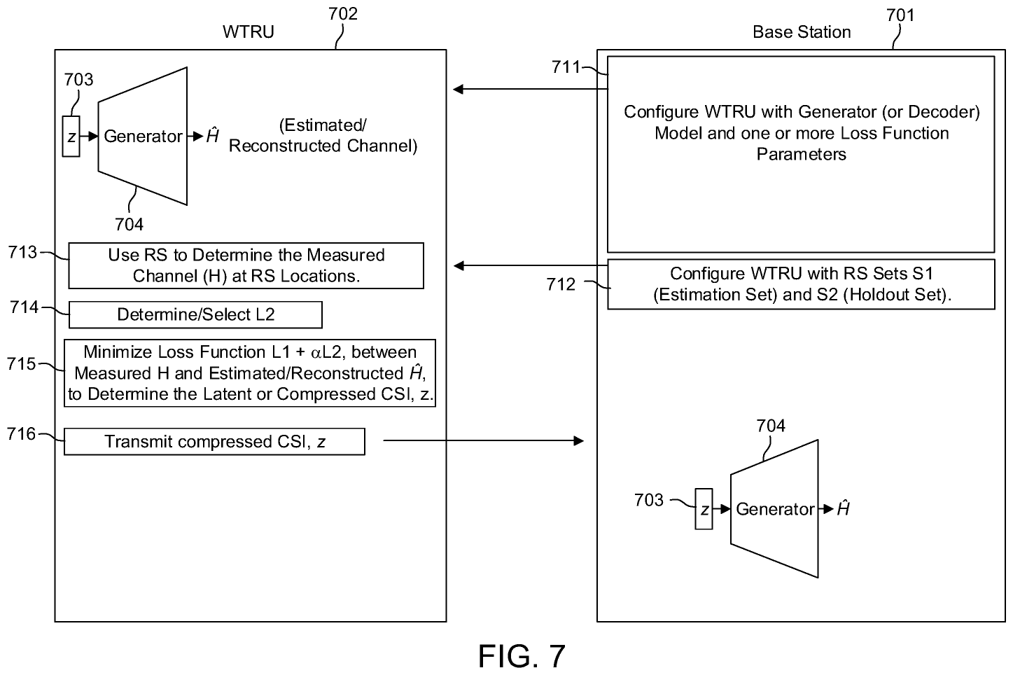

FIG. 7 illustrates an example of the generation and transmission of compressed CSI. There may be a WTRU 702 and a base station 701. The Base station may configure the WTRU with a generator or decoder model, and one or more loss function parameters (e.g., L1 (Reconstruction Loss), L2 (Property based Loss, ‘Low Rank’, ‘Sparsity’, etc.), and Weighting α. Note, for L2, a May be dynamically configured/changed by the base station, or selected by the WTRU from available options. At 712, the base station 701 may configure the WTRU with RS set S1 (estimation set) and S2 (holdout set). At 713, the WTRU 702 may use the RS indicated in the configuration to determine the measured channel (H) at RS locations. At 714, the WTRU 702 may minimize the loss function L1+αL2, between measured H and estimated/reconstructed Ĥ, to determine the latent vector (e.g., compressed CSI). At 716, the WTRU 702 may send the latent vector to the base station 701. Since both the WTRU 702 and the base station 701 know all of the parameters, once the base station 701 has the latent vector, it can calculate the channel matrix H (e.g., measured CSI). The weighting, α, may either be signalled by base station as in 711 or maybe determined by the WTRU based on the estimation and holdout set, wherein the WTRU generates several channel estimates for different values of α and selects the one which is the closest to the channel estimates at the RS locations evaluated from the holdout set.

In some cases, conditional compression may be used for channel estimation. In one or more example disclosed herein, an autoencoder may be used, but the associated techniques may be applied to any generative AI/ML model or variations thereof.

The transformation from the latent space (e.g., z) to the channel matrix (e.g., H) may be expressed as a function φ₂(⋅) The function φ₂(⋅) may be learned using different types of AI/ML model architectures/approaches. For example, the function φ₂(⋅) may be learned/implemented using decoder portion of autoencoder. For example, the function φ₂(⋅) may be learned/implemented using a Variational Auto Encoder (VAE) approach or variations thereof. For example, the function φ₂(⋅) may be learned/implemented using Generative Adversarial Networks (GANs) approach or variations thereof. For example, in the GAN approach, the model may be trained in a Generator-Discriminator setting. For example, the Generator may be configured to generate channel estimate samples from a latent space and Discriminator may be configured to distinguish real channel estimate samples from generated channel estimate samples. The training may be performed such that the generator may generate channel estimate samples that cannot be differentiated from the real channel estimate samples. Possibly the adversarial loss function may be used for training GAN models.

Conditional GANs may enable the generation of channel estimate samples with additional conditional vector as input to the AI/ML model (e.g., procedure(s) for training conditional GANs as disclosed herein).

For example, the GAN AI/ML model may be conditioned to produce channel estimate based on the conditional vector. For example, the conditional vector may be used to provide prior information that may optimize the determination of latent vector and/or generation of channel estimate. For example, the conditional vector may be configured to input information related to channel characteristics/properties/statistics. For example, the conditional vector may indicate or may be derived as a function of the expected channel rank. For example, the conditional vector may be configured such that the AI/ML model may produce a channel matrix with a specific rank. For example, the conditional vector may indicate or may be derived as a function of number of clusters and/or gain. For example, the conditional vector may indicate or may be derived as a function of coherence time of the channel. For example, the conditional vector may indicate or may be derived as a function of doppler estimation. For example, the conditional vector may indicate or may be derived as a function of sparsity of the channel in a preconfigured basis. Possibly the basis may be configured as a DFT basis. For example, the conditional vector may indicate or may be derived as a function of SNR.

In some cases, the conditional vector may be determined by the WTRU. For example, the WTRU may determine the conditional vector or a part thereof. The component of conditional vector determined by the WTRU may be referred to as Cu.

For example, the WTRU may use the previous channel estimates generated by the AI/ML model to determine parts of conditional vector. For example, the WTRU may use non-AI/ML methods to determine the conditional vector or parts thereof. For example, the WTRU may perform channel measurements to determine the conditional vector or parts thereof. For example, the WTRU may be configured with a mapping between different channel ranks and the value of conditional vector Cu. During inference, the WTRU may be configured to set the conditional vector Cu as the determined rank of the channel and the preconfigured mapping to Cu. For example, the WTRU may be configured with a mapping between different doppler spread ranges and the value of conditional vector Cu. During inference, the WTRU may be configured to set the conditional vector Cu as the measured doppler spread of the channel and the preconfigured mapping to Cu. For example, the WTRU may be configured with a mapping between different SNR ranges and value of conditional vector Cu. During inference, the WTRU may be configured to set the conditional vector Cu based on the SNR measurement and the preconfigured mapping to Cu.

In one instance, the conditional vector may indicate explicitly or implicitly an aspect/property associated with the AI/ML model input. For example, the AI/ML model may be trained such that the model may treat different bits of the latent vector differently based on the conditional vector. For example, the conditional vector may indicate the dimension of latent vector input to the AI/ML model. For example, this may allow for variable size of latent vector. For example, the AI/ML model may be trained to consider three possible lengths of latent vector, the conditional vector may indicate length of associated latent vector during inference. In one instance, the WTRU may be configured with the length and format of the conditional vector Cu by the base station.

In some cases, the WTRU may receive the conditional vector to apply for inference signaled from the base station. For example, the base station may determine the conditional vector based on one or more of the following: feedback from other WTRUs or based on deployment knowledge etc. The base station configured value for conditional vector may be referred to as Cn. For example, the WTRU may obtain the Cn based on signaling from the base station. For example, the signaling may be part of CSI measurement configuration. For example, the signaling may be part of CSI reporting configuration. For example, the WTRU may obtain the Cn or parts thereof as part of aperiodic CSI request from the base station.

In some cases, the conditional vector may be made of multiple parts. For example, different parts of conditional vector Ci may be associated with different channel characteristics/properties described herein. For example, different parts of conditional vector Ci may be associated with different WTRU measurements described herein. For example, the different channel properties/WTRU measurements may include one or more of: channel rank, sparsity of channel in DFT basis, coherence time, doppler information, number of clusters, channel gain, SNR, SINR, CQI, and/or the like. Different conditional vectors each corresponding to different channel characteristics may be configured/determined and may be concatenated to form an input conditional vector. The values in Ci may be set to the previous Ci value if the WTRU measurements are unknown or not available during inference. The values in Ci may be set to a predefined value if the WTRU measurements are unknown or not available during inference. In one instance, different parts of conditional vector Ci may be made of WTRU based component Cu and base station configured component Cn. In one instance, the format of the conditional vector Ci and the lengths of different parts of Ci may be configured by the base station.

The WTRU may be configured with a conditional GAN AI/ML model to generate the CSI feedback or parts thereof. In one approach, the conditional GAN AI/ML model may be configured to generate channel estimate when latent vector Z and optionally a conditional vector Ci is provided as input to the model. The AI/ML model may be configured and/or trained to generate different channel estimates based on the value of conditional vector given the same latent vector. For example, the WTRU may be configured to report the CSI feedback that includes the value of latent vector Z. For example, the WTRU may be configured to report the CSI feedback based on the value of latent vector Z. For example, the WTRU may determine latent vector Z such that when Z is input to the AI/ML model produces at the output the channel estimate that satisfies a preconfigured condition. For example, the preconfigured condition may be expressed as a minimization of a loss function. For example, at least a part of the loss function may depend on network configuration. In one example, the loss function may be configured as the difference between a first channel estimate and a second channel estimate. For example, the first channel estimate may correspond to the channel estimate over the CSI-RS symbols. For example, the second channel estimate may be a function of channel estimate output of the AI/ML model. For example, the second channel estimate may correspond to the output of AI/ML model when latent vector Z and/or conditional vector Ci is input to the AI/ML model. For example, the second channel estimate may correspond to sampled version of the output of AI/ML model when latent vector Z and/or conditional vector Ci is input to the AI/ML model. In some instances, the WTRU may be configured to determine the sampled version based on a sampling operator, wherein the sampling operator may be preconfigured. The reconfiguration may be implicit or explicit. For example, the WTRU may implicitly determine the sampling operator as a function of CSI-RS configuration. For example, the WTRU may explicitly determine the sampling operator based on network configuration.

In some cases, the WTRU may input the conditional vector Ci when configured by the network. In one case, the conditional vector Ci may be equal to the conditional vector Cn, wherein the conditional vector Cn is configured by the network. In another case, the conditional vector Ci may be equal to the conditional vector Cu, wherein the conditional vector Cu may be determined by the WTRU. In another case, the input conditional vector Ci may be a combination of Cu and Cn.

In one case, the WTRU may be configured to input a default conditional vector Ci when one or more of the following conditions are true: when the WTRU is not configured with Cn and/or when the WTRU is not configured to or cannot determine Cu. In one case, the default conditional vector Ci may be a NULL vector. In another case, the default conditional vector may be predefined to a specific value.

The WTRU may determine the latent vector Z which minimizes the loss function associated with channel estimate when optimal Z is input to a conditional GAN model conditioned upon the conditional vector Ci. In some implementations both Z and Ci may be configured as input to the AI/ML model, and the channel estimate is the output of the AI/ML model. For example, the latent vector Z may serve as the compressed representation of the channel estimate.

The WTRU may be configured to transmit the CSI feedback containing the latent vector Z and at least a portion of the conditional vector Ci. For example, the WTRU may be configured to feedback the Cu portion of the conditional vector Ci, if Ci is composed of Cn and Cu. For example, the WTRU may be configured to feedback the whole Ci, if the Ci is composed of only Cu. For example, the WTRU may be configured to skip the transmission of Ci, if the Ci is composed of only Cn. In some instances, the WTRU may be configured to transmit a quantized version of Ci in the CSI feedback. For example, the conditional vector Ci may serve side information to help recover/reconstruct the channel estimate based on the latent vector Z.

In one case, the WTRU may transmit both the latent vector Z and conditional Ci in the same CSI feedback. For example, the first part of the CSI feedback may contain the latent vector Z and a second part of the CSI feedback may contain the conditional vector Ci. In another case, the WTRU may be configured with a mapping between Ci or parts thereof to UL resources. The WTRU may implicitly indicate the value of Ci by transmitting CSI feedback in associated preconfigured UL resources (e.g., PUCCH resources). In some instances, the WTRU may indicate the value of Ci implicitly via CSI report quantity, such as Rank Indication, SINR, etc.

In one case, the WTRU may transmit latent vector Z and conditional vector Ci in different messages. The WTRU may transmit latent vector Z in a first type of CSI feedback and conditional vector Ci in a second type of CSI feedback message. The periodicity of latent vector Z feedback and periodicity of conditional vector Ci feedback may be configured with different values. For example, the WTRU may be configured to report the conditional vector Ci in semi-persistent CSI feedback. For example, the WTRU may be configured to report the conditional vector Ci only if it changes from the previous report.

In some cases, a WTRU may be configured with one or more of resource sets which may be used for at least one of channel observation, inference time model selection, model (re) tuning, reference signal overhead reduction, transfer learning, and/or online learning, wherein resource set may be interchangeably used with set, observation set, channel matrix estimate set, channel observation set, channel estimation set, measurement resource set, data set, estimation set, holdout set, training set, test set, and/or validation set.

In an example, a WTRU may be configured with two resource sets or determined to use two resource sets, wherein a first resource set may be a channel observation set which may be used by a channel estimation model(s) for estimating the channel matrix and a second resource set may be a holdout set which may be used for determining, estimating, and/or monitoring estimation performance (e.g., channel estimation performance from the channel estimation model(s). The first and second resource sets may be configured in one or more ways.

The first resource set (e.g., channel observation set) may be configured with one or more measurement reference signals (e.g., CSI-RS, NZP-CSI-RS, TRS, SSB) and the second resource set (e.g., holdout set) may be configured with one or more resources carrying data (e.g., PDSCH REs, PDCCH REs); alternatively, the second resource set may be configured with demodulation reference signal (e.g., DM-RS).

The first resource set may be configured with one or more measurement reference signals with a higher density (e.g., 3REs/RB) while the second resource set may be configured with one or more measurement reference signals with a lower density (e.g., 1RE/RB).

The first resource set may be configured with one or more measurement reference signals with a certain periodicity (e.g., periodic CSI-RS, SSB) while the second resource set may be configured with one or more measurement reference signals which may be transmitted aperiodically or semi-persistently (e.g., aperiodic CSI-RS, semi-persistent CSI-RS).

The first resource set may be configured via a higher layer (e.g., RRC, MAC-CE) and the second resource set may be dynamically indicated via a L1 signaling (e.g., DCI).

The presence of the second resource set in a slot may be indicated by a DCI and a WTRU may perform or determine performance of estimation model when the WTRU is indicated for the presence of the second resource set in the slot.

The presence of the second resource set may be implicitly indicated by a triggering signal for determining performance of estimation model (e.g., a base station may trigger to perform performance check of the estimation model).

The first resource set may be configured by base station while the second resource set may be determined by WTRU. For example, the first resource set may be one or more configured measurement reference signal and the second resource set may be determined by WTRU within the candidate resources, wherein the candidate resources include at least one of measurement reference signal, data REs, and demodulation reference signal.

In another example, when a WTRU receives the second set of resource in a downlink slot, the WTRU may determine a performance (e.g., performance of an estimation model, performance of a compression model, or performance of a prediction model); then, based on the determined performance, the WTRU may perform one or more subsequent behaviors. The subsequent behaviors include at least one of the following: report preferred, recommended, or optimized configuration information for the first set of resource including at least one of measurement reference signal overhead, periodicity, and/or density; determine and/or report a decoder model (or a decoder) for channel estimation within one or more decoder models; and/or, determine and/or report one or more parameters related to loss function (e.g., a).

In some cases, a RS selection may be based on a holdout set. During the downlink transmission the base station may transmit 2 sets of RS symbols (e.g., CSI-RIS) set S1 and set S2, where S1 and S2 may be non-overlapping sets. The set S1 is termed as the estimation set (which will be used by the channel estimation models for estimating the channel) and the set S2 is termed as the holdout set which is used for estimation performance measurement.

From the estimation set S1, N subsets may be configured by the base station [S11, S12, . . . S1N]. These sets may or may not have overlapping elements and may be of different sizes and represent multiple different potential patterns and different density of RS signals in frequency/time/space domains. The information pertaining to the N subsets may be configured by the base station using scheduling (PDCCH/DCI-based) and high-layer configuration (RRC or MAC-CE) to cater for different use cases and WTRU capabilities. It may also be possible to have default configurations in place (pre-configured). The WTRU accordingly receives CSI-RS using the first CSI-RS configuration set S1.

The decoder model is used for channel estimation and compression with each of these N sets, and the channel estimation performance of each of these N sub-sets is gauged on the elements of set S2. The error with reference to S2 may be utilized for selecting the subset with the optimal RS pattern and lowest number of RS symbols while providing the desired error in channel estimation.

The base station may configure the performance error threshold T for the selection of the optimal subset of S1 (e.g., a third CSI-RS configuration set). Specifically, the third CSI-RS configuration set follows from the loss function L1 being below the predefined threshold T, where L1 is the difference between H1 (e.g., channel estimates over the first CSI-RS configuration set) and sampled H2 (e.g., output of the decoder AI/ML model after sampling operator). The base station may explicitly using scheduling or high-layer signaling, or implicitly using certain selection of DL resources, indicate the threshold T to the WTRU. The WTRU, upon determination of the optimal subset of S1, indicates the selection to the base station using explicit UL control signaling or implicit through selection of certain UL resources.

As disclosed herein, the estimation performance measurement may be made against the hold-out set in S2. In particular, the error with respect to the S2 may be used for adaptively selecting the RS for subsequent transmissions. Reducing number of reference signals: the subsets of S1 may potentially have different number of observations (S1a: 5% of S1, S1b: 10% of S1, . . . ). The holdout sets, S2, may then be utilized to gauge the performance and thus select the subset of S1 with minimum required number of RS symbols that need to be transmitted to achieve the required channel estimation performance at run time.

The WTRU may accordingly report the optimal RS to the base station using dedicated UL control signaling (e.g., modified UCI in PUCCH or PUSCH) or through certain selection of the UL resources (e.g., PRACH/PUCCH/PUSCH/SRS etc.). In one case, the RS density in time or/and frequency may be indicated through percentage increase/decrease or using simple up/down commands. In another case, the specific positions of the RS on the resource grid (RS pattern) may be indicated. Part of the RS indication may include a starting X time for the use of the selection.

In some instances, the 2nd set (or the holdout set) may be configured on demand. The WTRU may issue a separate trigger to request the holdout set to tune one or more functionalities, in particular with respect to RS selection. Along with the trigger, the WTRU may also specifies one or more functionalities/use cases that will be tuned using the holdout set. Depending on the use cases, one or more holdout sets may need to be sent as each use case/functionality may require a different configuration of holdout set. The demand for the 2nd set may also be triggered by the base station depending on some performance monitoring metrics that the base station may evaluate.

In some cases, loss selection may be performed based on a holdout set. A WTRU may be configured to transmit CSI feedback containing a latent vector applicable for a preconfigured decoder AI/ML model, wherein the WTRU may be configured with a decoder AI/ML model, and a loss function L associated with the decoder AI/ML model, wherein the decoder AI/ML model may be used at the NW to reconstruct the CSI based on compressed CSI feedback.

In some instances, a WTRU may be configured with a preconfigured loss function L, with two loss components L1 and L2, such that L is a combination of L1 and L2. An example of this would be L=L1+αL2, where first loss component, L1, is associated with the difference or the mean squared error between H1 (e.g., channel estimates over the first CSI-RS configuration set) and sampled H2 (e.g., output of the decoder AI/ML model after sampling operator). The second loss component L2, may be associated with a base station specified property of the channel. An example of this property would be that the estimated channel should be ‘low rank’ or ‘sparse’ and a low rank loss like the Nuclear Norm or a sparse loss like l1-Norm or Group-sparse norm may be utilized as the second loss component. The parameter α may be associated with weightage of L2 with respect to L1.

The base station may configure and indicate the loss component L2 to the WTRU, for example based on the deployment scenario. It one case, the loss component L2 may be preconfigured, such as during initial access procedure. In another case, the base station may configure a set of candidate loss components for L2 to the WTRU, whereby the WTRU select the preferred candidate based on performance monitoring. In this case, the WTRU may indicate the selection of L2 to the base station, such to assist the base station with the reconstruction of the CSI based on compressed CSI feedback. The potential set of loss functions may be predefined as a codebook and may be indicated to the WTRU by using the index of the corresponding loss in the codebook. The indication for loss component L2, or candidate loss components for L2 from the base station may be done explicitly through downlink control signaling, or implicitly through certain selection of downlink resources. On the other hand, for signaling the choice of L2 out of the candidate sets to the base station, the WTRU may use dedicated uplink control signaling, or implicit indication with certain selection of resources in the uplink physical channels or reference signals.

Moreover, the base station may configure and indicate the parameter α to the WTRU. In another case, the base station may configure a set of candidate values for α or Loss L2, whereby the WTRU decides on the ultimate choice. To select the weight α or the loss function L2 among the potential candidate values of α or loss L2, respectively, the WTRU may use performance monitoring whereby for a given α or L2 the loss function L is minimized over the first CSI-RS configuration set (S1), or over one or several CSI configurations out of a subset of S1. The indication for parameter α or L2, or candidate values for parameter α and L2 from the base station may be done explicitly through downlink control signaling, or implicitly through certain selection of downlink resources. On the other hand, for signaling the choice of parameter α or L2 out of the candidate sets to the base station, the WTRU may use dedicated uplink control signaling, or implicit indication with certain selection of resources in the uplink physical channels or reference signals.

In one instance, α or L2 loss selection by the WTRU may include utilizing the set S1 to estimate channel estimates for α or loss component L2, and this may be separately carried out for a number of candidate options configured and indicated by the base station. Note, the first loss component L1 may be configured by RRC, MAC-CE, or dynamic L1 signaling. In one instance, the a/Loss selection, or selected candidates, may be indicated using MAC-CE or dynamic L1 signaling.

In some cases, the triggers of S1 and S2 related to α or L2 Loss selection may be different than those related to RS selection. For example, base station may have several potential L2 loss functions that it may configure the WTRU with. For different loss functions, different transmission configurations may be required. Depending on the loss function definition, it may have multiple tunable parameters that will have to be configured at the WTRU. In one example, the L2 loss may be changed as the channel conditions are change and the frequency at which L2 is modified may be predefined or may be triggered by the base station.

In some cases a model may be selected based on a holdout set. A WTRU is configured to transmit CSI feedback containing a latent vector applicable for a preconfigured decoder AI/ML model. The WTRU may be configured with a set of multiple decoder AI/ML models, and fixed a loss function L associated with all the decoder AI/ML models, wherein multiple decoder models are configured for evaluating the CSI feedback, and the optimal decoder AI/ML model may be used at the NW to reconstruct the CSI based on compressed CSI feedback.

For example, the WTRU may be configured with at least CSI-RS configuration sets: a first CSI-RS configuration set and a second configuration set, wherein the first CSI-RS configuration set is estimation set and second CSI-RS configuration set is a holdout set (e.g., S1 and S2 are non-overlapping sets).

The base station may configure and indicate decoder models, or the decoder models may be pre-configured, (e.g., during the initial access procedure). The base station may indicate the candidate decoder models using explicit signaling (e.g., RRC, MAC-CE, DCI/PDCCH) or implicit signaling (e.g., certain resource selection in PDSCH, PDCCH, CSI-RS, etc.).

The WTRU and base station may have a set of N potential pre-trained decoder models

$$( {ϕ}_{2}^{( 1 )} , … , {ϕ}_{2}^{( N )} ) .$$

Each of the models may be used for channel estimation and compression with set S1 and the performance is evaluated on set S2. The model with the lowest error on S2 may be utilized for compressing the channel to z. The WTRU may select the decoder model from the candidate set in order to minimize the loss function (e.g., selecting latent vector Z that minimized L over S1 or subset of S1). The WTRU may then indicate to the base station, either explicitly through dedicated UL signaling, or implicitly through selection of certain UL resources, the choice of the decoder model that should be used to estimate the channel from the compressed representation z. Multiple different models may be used for channel estimation using the observations in S1 and their performance may be compared on the set S2. Set S2 may be used for run-time parameter tuning of the ML models. For example, in one case there may be selection of the weightage of the low rank inducing nuclear-norm parameter based on the performance on S2.

The configurations for S1 and S2 related to model selection may be different from previous cases focused on RS selection and α or L2 loss selection. Separate triggers may be used for S2 for model selection as compared to previous cases, including being asynchronous from other optimizations.

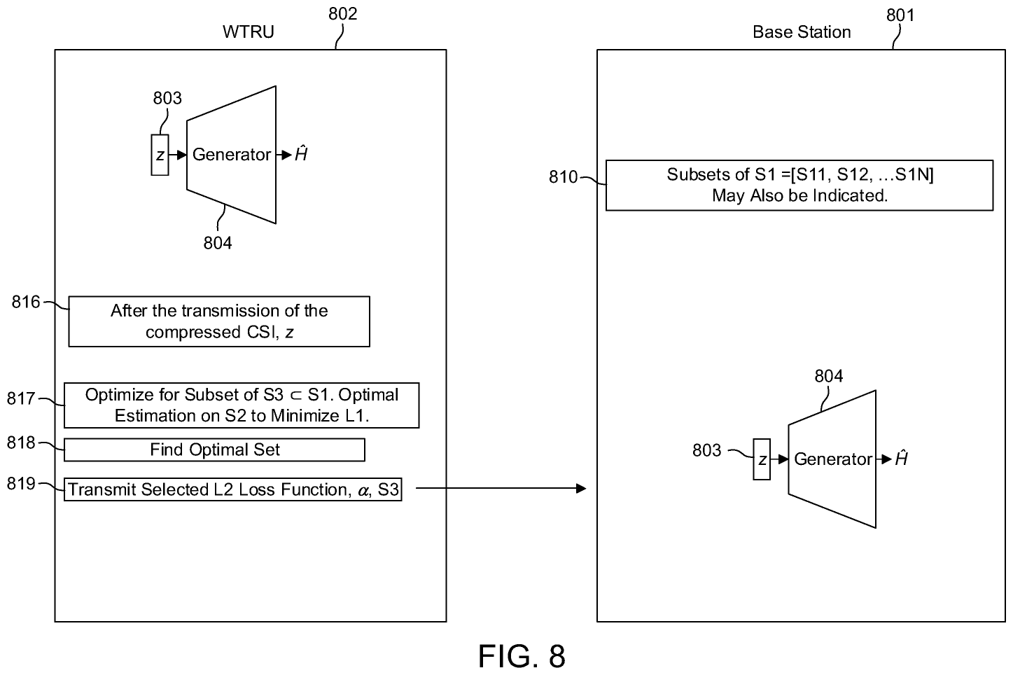

FIG. 8 illustrates an example of using a holdout-set for RS selection. Initially, a WTRU 802 and a base station 801 may undergo a process for channel estimation using an AI/ML model (as described herein). The WTRU 802 may transmit the latent vector (z) at 816. At some point before or after, the base station may indicate one or more subsets of S1, where previously configured S1 is an estimation set and S2 is a holdout set. At 817, the WTRU 802 may optimize for subset S3 of S1, where S3 is the smallest subset of S1 such that one or more loss functions (in any variation described herein described herein) is below a threshold. At 818, the WTRU 802 may find an optimal subset S3. This third set (S3) may need to satisfy one or more criteria, such as: it is the smallest subset of the configured set such that the loss function is below a threshold. At 819, the WTRU may transmit a report, including S3, and one or more selected loss functions and/or a (e.g., as part of the loss function).

In one example, there may be a method/device for Generative CSI feedback. A WTRU is configured to transmit CSI feedback containing a latent vector applicable for a preconfigured decoder AI/ML model. The WTRU may be configured with a decoder AI/ML model, and a loss function L associated with the decoder AI/ML model. The decoder AI/ML model may be used at the NW to reconstruct the CSI based on compressed CSI feedback. The WTRU may receive CSI-RS based on a CSI-RS configuration. The WTRU may determine a latent vector Z which satisfies following one or more criteria: Minimizes the preconfigured loss function L, where the loss function is the difference or the mean squared error between H1 and sampled H2, H1 is the channel estimates over the CSI-RS symbols, H2 is the output of decoder AI/ML model when latent vector Z is input to the decoder model, and/or the sampling operator is a function of CSI-RS configuration; and/or, the WTRU may be configured to use the output of decoder AI/ML model H2 as the channel estimate over the entire channel. The WTRU may transmits the CSI feedback containing at least the latent vector Z or a quantized/coded version thereof

In one example, there may be a method/device for generative CSI feedback with multi-property loss. A WTRU is configured to transmit CSI feedback containing a latent vector applicable for a preconfigured decoder AI/ML model. The WTRU may be configured with a decoder AI/ML model, and a loss function L with a first loss and second loss component associated with the decoder AI/ML model. The decoder AI/ML model may be used at the NW to reconstruct the CSI based on compressed CSI feedback. The WTRU may receive CSI-RS based on a CSI-RS configuration. The WTRU may determines a latent vector Z that satisfies one or more criteria. One or more criteria may minimize the preconfigured loss function L, configured to have two loss components L1 and L2), such that L is a combination of L1 and L2. An example of this may be L=L1+αL2.

In one instance, a first loss component, L1, may be associated with the difference or the mean squared error between H1 and sampled H2. H1 may be the channel estimates over the CSI-RS symbols. H2 may be the output of decoder AI/ML model when latent vector Z is input to the decoder model. The sampling operator is a function of CSI-RS configuration

In one instance, a second loss component L2, may be associated with a base station specified property of the channel. An example of this property may be that the estimated channel should be ‘low rank’ or ‘sparse’ and a low rank loss like the Nuclear Norm or a sparse loss like l1-Norm or Group-sparse norm may be utilized as the second loss component.

In one instance, the first loss component may be configured via RRC configuration, and the second loss component may be configured semi-statically or dynamically (e.g., via MAC CE or L1 signaling).

The WTRU may transmits the CSI feedback containing at least the latent vector Z or a quantized/coded version thereof.

In one example, there may be a method/device for RS selection based on holdout set(s). A WTRU is configured to transmit CSI feedback containing a latent vector applicable for a preconfigured decoder AI/ML model. The WTRU may be configured with a decoder AI/ML model, and a loss function L associated with the decoder AI/ML model. The decoder AI/ML model may be used at the NW to reconstruct the CSI based on compressed CSI feedback.

The WTRU may be configured with at least a first CSI-RS configuration set, a second configuration set, and a plurality of subsets with respect to the first CSI-RS configuration set. The first CSI-RS configuration set is estimation set and second CSI-RS configuration set is a holdout set. The first CSI-RS configuration and second CSI-RS configuration may be non-overlapping sets.

The WTRU may receive CSI-RS using the first and second CSI-RS configuration set.

Among all preconfigured subsets with respect to the first CSI-RS configuration set, the WTRU may determine a third CSI-RS configuration set which satisfies one or more. One or more criteria may include where the third CSI-RS configuration set is a smallest subset of first CSI-RS configuration set such that the loss function L1 is below the predefined threshold T. The loss function L1 may be the difference between H1 and sampled H2. H1 may be the channel estimates obtained from the second CSI-RS configuration set corresponding to the holdout set. H2 may be the output of decoder AI/ML model when latent vector Z is input to the decoder model. For each preconfigured subsets with respect to the first CSI-RS set, a latent vector Z is independently evaluated by minimizing the loss function L. The sampling operator may be a function of third CSI-RS configuration set.

The WTRU may transmit a report indicating the identity of the third CSI-RS configuration set

In one example method/device, an alpha selection may be made based on a holdout set. A WTRU is configured to transmit CSI feedback containing a latent vector applicable for a preconfigured decoder AI/ML model. The WTRU may be configured with a decoder AI/ML model, and a loss function L associated with the decoder AI/ML model. The decoder AI/ML model may be used at the NW to reconstruct the CSI based on compressed CSI feedback.

The WTRU may be configured with a preconfigured loss function L, with two loss components L1 and L2, such that L is a combination of L1 and L2. An example of this would be L=L1+αL2.

In one instance, a first loss component, L1, may be associated with the difference or the mean squared error between H1 and sampled H2. H1 may be the channel estimates over the first CSI-RS configuration set. H2 may be the output of decoder AI/ML model when latent vector Z is input to the decoder model. The sampling operator for H2 is a function of first CSI-RS configuration set.

In one instance, a second loss component L2, is associated with a base station specified property of the channel. An example of this property may be that the estimated channel is ‘low rank’ or ‘sparse’ and a low rank loss like the Nuclear Norm or a sparse loss like l1-Norm or Group-sparse norm may be utilized as the second loss component.

In one instance, the parameter α is associated with weightage of L2 with respect to L1.

In one instance, the first loss component may be configured via RRC configuration, and the second loss component and a set of preconfigured values for α may be configured semi-statically or dynamically (e.g., via MAC CE or L1 signaling).

The WTRU may be configured with at least a first CSI-RS configuration set and a second configuration set. The first CSI-RS configuration set may be estimation set and second CSI-RS configuration set may be a holdout set. The first CSI-RS configuration and second CSI-RS configuration may be non-overlapping sets.

The WTRU may receive CSI-RS using the first and second CSI-RS configuration set. Among all preconfigured values for α, the WTRU may determine the value of α which satisfies one or more of criteria. One or more criteria may include minimizing the loss function L3. The loss function L3 may be the difference between H1 and sampled H2. H1 may be the channel estimates obtained from the second CSI-RS configuration set corresponding to the holdout set. H2 may be the output of decoder AI/ML model when latent vector Z may be input to the decoder model. The sampling operator for H2 may be a function of the second CSI-RS configuration set. The latent vector Z may be evaluated by minimizing the loss function L=L1+αL2, for a given value of α over the first CSI-RS configuration set.

The WTRU may transmits a report indicating the value of the selected α.

In one example, there may be a method/device for model selection based on a holdout set. A WTRU is configured to transmit CSI feedback containing a latent vector applicable for a preconfigured decoder AI/ML model. The WTRU may be configured with a set of multiple decoder AI/ML models, and fixed a loss function L associated with all the decoder AI/ML models. The multiple decoder models may be configured for evaluating the CSI feedback. The optimal decoder AI/ML model may be used at the NW to reconstruct the CSI based on compressed CSI feedback.

The WTRU may be configured with at least CSI-RS configuration sets: a first CSI-RS configuration set and a second configuration set. The first CSI-RS configuration set may be an estimation set and the second CSI-RS configuration set may be a holdout set. The first CSI-RS configuration and second CSI-RS configuration may be non-overlapping sets.

The WTRU may receive CSI-RS using the first and second CSI-RS configuration set.

Among all preconfigured decoder models, the WTRU may determine the decoder that satisfies one or more criteria. One or more criteria may include minimizing the loss function L3. The loss function L3 may be the difference between H1 and sampled H2. H1 may be the channel estimates obtained from the second CSI-RS configuration set corresponding to the holdout set. For a given decoder model from the available set of pre-configured models, H2 may be evaluated as the output of the decoder AI/ML model when latent vector Z is input to the decoder model. For each given decoder, the latent vector Z may be independently evaluated by minimizing the loss function L=L1+α L2 over the first CSI-RS configuration set. The sampling operator for L3 may be a function of second CSI-RS configuration set.

The WTRU may transmit a report indicating the latent vector Z and the selected decoder AI/ML model for CSI estimation.

In one example there may be a method/device for conditionally compressive or conditionally generative modeling for channel estimation. A WTRU is configured to transmit CSI feedback containing a latent vector based on conditionally compressive/generative model. The WTRU may be configured with a generative AI/ML model and optionally conditional vector Cn configured by network. The generative AI/ML model may generate the channel estimate given α latent vector based on a training procedure. For the training, a generator G, a discriminator D, and a Loss function L may be utilized and satisfy one or more criterion.

One or more criterion may be, for example, one or more of the following: where the generator takes as input a compressed CSI Z and conditional vector Cn and produces a tensor same in size as the required channel; the discriminator takes as input a channel tensor and gives a binary classification output to identify if the given input is a valid channel or not; the training is performed to minimize the preconfigured loss function L, configured to have two loss components L1 and L2, such that L is a combination of L1 and L2. An example of this would be L=L1+αL2; a first loss component, L1, is associated with binary classification accuracy to predict if the input channel passed to the discriminator comes from the discriminator or comes from a training dataset of pre-configured channels; a second loss component L2, is associated with specified optionally conditional vector Cn. And measures if the conditioned indicated by Cn is imposed at the generator output; and/or, the first loss component may be configured via RRC configuration, and the second loss component may be configured semi-statically or dynamically (e.g., via MAC CE or L1 signaling). In some instances, the conditional vector Cn may be associated with channel statistics known prior (e.g., including but not limited to rank, sparsity of channel in DFT basis, coherence time, doppler information, number of clusters, gain, SNR etc.).

The WTRU may determines a latent vector Z along with the optional conditional vector Ci previously known. The evaluation of Z may satisfy one or more criteria. One or more criteria may include minimizing the preconfigured loss function f. The loss function may be the difference between H1 and sampled H2. H1 may be the channel estimates over the CSI-RS symbols. H2 may be the output of decoder AI/ML model when latent vector Z and Ci may be input to the decoder model. The sampling operator may be a function of CSI-RS configuration. One or more criteria may include Ci is a combination of Cn (including a null value) and Cu. Cu may be a conditional vector determined based on WTRU measurement associated with channel statistics. One or more criteria may include when the WTRU uses the output of decoder AI/ML model H2 as the channel estimate over the entire channel.

The WTRU may transmit the CSI feedback containing at least the latent vector Z and the WTRU component of the conditional vector Cu or a quantized/coded version thereof.

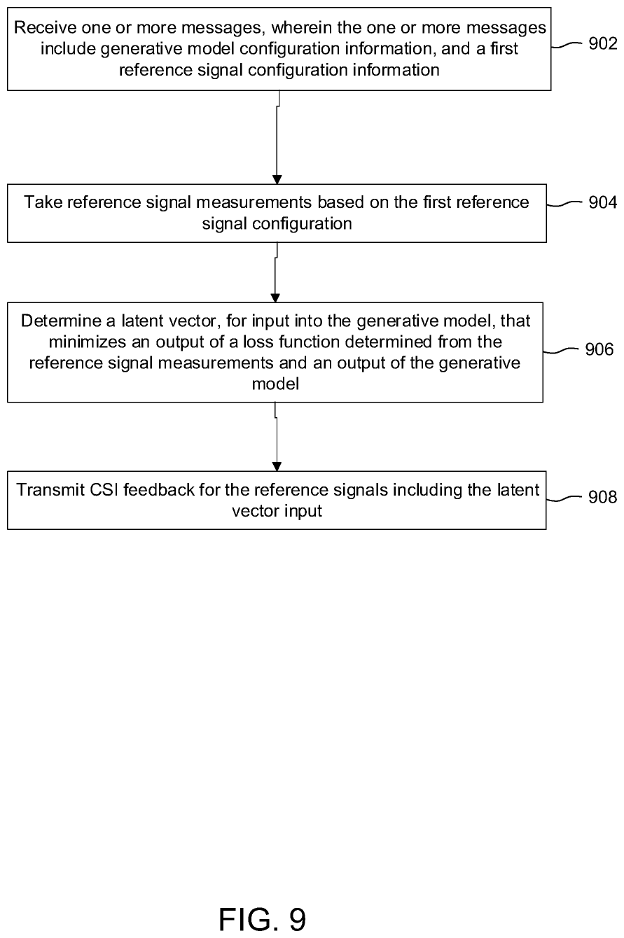

FIG. 9 illustrates an example process of transmitting a latent vector. A WTRU may have receive one or more messages, wherein the one or more messages include generative model configuration information, and a first reference signal configuration information. At 904, the WTRU may take reference signal measurements based on the first reference signal configuration. At 906, the WTRU may determine a latent vector, for input into the generative model, that minimizes an output of a loss function determined from the reference signal measurements and an output of the generative model. At 908, the WTRU may transmit CSI feedback for the received reference signals including the latent vector input. In some instance, the one or more messages further includes one or more loss function parameters including a first loss component value, one or more second loss component values, and one or more alpha values, wherein each alpha value represents a weight for one or more second loss component value with respect to the first loss component value. In some instance, the loss function is determined based on the first loss component value, a selected second loss component value from the one or more second loss component values, and a selected alpha value from the one or more alpha values. In some instance, the loss function is defined as the sum of the selected L2 value multiplied by the selected alpha value, and the L1 value. In some instance, the determining the selected L2 value and the selected alpha value are based on measurements performed on the received reference signals. In some instance, the first loss component value is configured via RRC configuration and is associated with the difference or the mean square error between the reference signal measurements and the output of the generative model for a specific latent vector. In some instance, the one or more L2 values is configured via one of RRC configuration, MAC CE, DCI, or layer one signaling and is associated with a gNB-specified property of the channel. In some instance, the determination of the selected L2 value or the selected alpha value is based on a received indication. In some instance, the CSI feedback transmission also includes the selected value of L2 or the selected value of alpha.

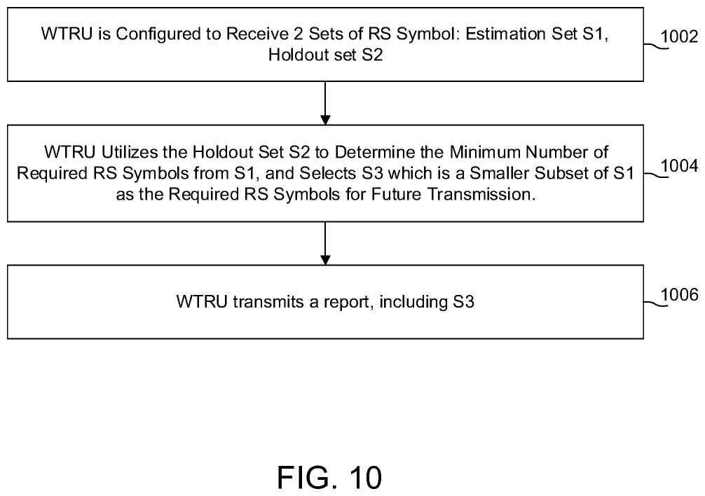

FIG. 10 illustrates an example process of transmitting an optimized subset of RS. At 1002, a WTRU may receive one or more messages that include configuration information. The configuration information may include at least two sets of RS symbols (e.g., CSI-RS): S1 estimation set and S2 hold out set. At 1004, the WTRU may utilize S2 to determine a minimum number of required RS symbols from S1 to generate a new set S3, which is a smaller subset of S1 as the required RS symbols for future transmission. At 1006, the WTRU may transmit a report, including S3. The report may include additional information relevant to the process, as described herein.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a wireless transmit receive unit (WTRU), the method comprising:
receiving one or more messages, wherein the one or more messages include generative model configuration information for a generative model, and a first reference signal configuration information;
taking reference signal measurements based on the first reference signal configuration information;
determining a latent vector, for input into the generative model, that minimizes an output of a loss function determined from the reference signal measurements and an output of the generative model; and
transmitting CSI feedback for the measured reference signals including the latent vector.

2. The method of claim 1, wherein the one or more messages further includes one or more loss function parameters including a first loss component value, one or more second loss component values, and one or more alpha values, wherein each alpha value represents a weight for one or more second loss component value with respect to the first loss component value.

3. The method of claim 2, wherein the loss function is determined based on the first loss component value, a selected second loss component value from the one or more second loss component values, and a selected alpha value from the one or more alpha values.

4. The method of claim 3, wherein the loss function is defined as a sum of the selected second loss component value multiplied by the selected alpha value, and the first loss component value.

5. The method of claim 4, wherein the determining the selected second loss component value and the selected alpha value are based on the reference signal measurements.

6. The method of claim 3, wherein the first loss component value is configured via RRC configuration and is associated with a difference or a mean square error between the reference signal measurements and the output of the generative model for a specific latent vector.

7. The method of claim 2, wherein the one or more second loss component values is configured via one of RRC configuration, MAC CE, DCI, or layer one signaling and is associated with a gNB-specified property of a channel.

8. The method of claim 3, wherein the determination of the selected second loss component value or the selected alpha value is based on a received indication.

9. The method of claim 2, wherein the CSI feedback also includes a selected second loss component value of the one or more second loss component values or a selected alpha value of the one or more alpha values.

10. A wireless transmit receive unit (WTRU), the WTRU comprising:
a processor operatively connected to a transceiver,
the processor and transceiver configured to receive one or more messages, wherein the one or more messages include generative model configuration information for a generative model, and a first reference signal configuration information;
the processor and transceiver configured to take reference signal measurements based on the first reference signal configuration;
the processor configured to determine a latent vector, for input into the generative model, that minimizes an output of a loss function determined from the reference signal measurements and an output of the generative model; and
the processor and transceiver configured to transmit CSI feedback for the measured reference signals including the latent vector input.

11. The WTRU of claim 10, wherein the one or more messages further includes one or more loss function parameters including a first loss component value, one or more second loss component values, and one or more alpha values, wherein each alpha value represents a weight for one or more second loss component value with respect to the first loss component value.

12. The WTRU of claim 11, wherein the loss function is determined based on the first loss component value, a selected second loss component value from the one or more second loss component values, and a selected alpha value from the one or more alpha values.

13. The WTRU of claim 12, wherein the loss function is defined as a sum of the selected second loss component value multiplied by the selected alpha value, and the first loss component value.

14. The WTRU of claim 13, wherein the determining the selected second loss component value and the selected alpha value are based on the reference signal measurements.

15. The WTRU of claim 12, wherein the first loss component value is configured via RRC configuration and is associated with a difference or a mean square error between the reference signal measurements and the output of the generative model for a specific latent vector.

16. The method of claim 11, wherein the one or more second loss component values is configured via one of RRC configuration, MAC CE, DCI, or layer one signaling and is associated with a gNB-specified property of a channel.

17. The method of claim 12, wherein the determination of the selected second loss component value or the selected alpha value is based on a received indication.

18. The method of claim 11, wherein the CSI feedback also includes a selected second loss component value of the one or more second loss component values or a selected alpha value of the one or more alpha values.
